(19) United States
(12) Patent Application Publication
(10) Pub. No.: US 2006/0178897 A1
(43) Pub. Date: Aug. 10, 2006

(54) Prospect Resource Information Management Environment

(75) Inventor: BIll A. Fuchs, Alamo, CA (US)

Correspondence Address: INTEGRITY LLC;BILL FUCHS, 2951 ROUNDHILL ROAD, ALAMO, CA, 94507, US

(73) Assignee: Bill A. Fuchs, Alamo, CA (US)

(21) Appl. No.: 11/164,842

(22) Filed: Dec. 7, 2005

(51) Int. Cl. G06Q 99/00

(52) U.S. Cl. 705/1

(57) ABSTRACT

PRIME© is an advanced Business Intelligence Environment, at its core is a preference capturing/preference profiling automated Business Intelligence Engine. It is designed to operate in a CRM (Customer Resource Management) and CEM (Client Experience Management) framework. It is a hybrid, heuristic, internet enabled advanced marketing environment which can enable any business to improve its customer service and overall business intelligence.

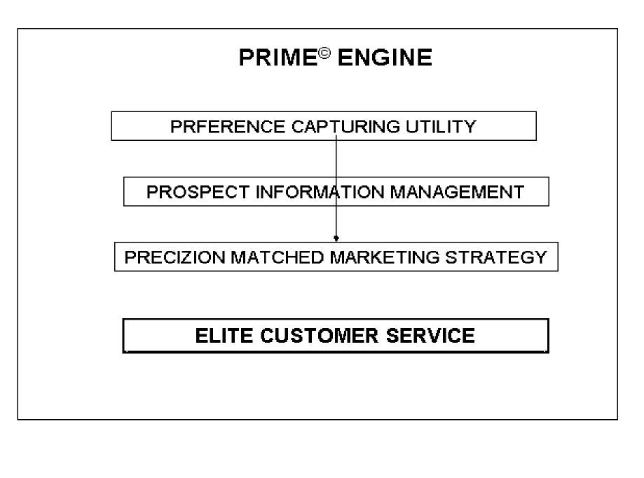

PRIME© is an advanced Business Intelligence Environment, at its core is a preference capturing/profiling automated Business Intelligence Engine. It is designed to operate in a CRM (Customer Resource Management) and CEM (Client Experience Management) framework.

It is a hybrid, heuristic, internet enabled advanced marketing environment which can enable any business to improve its customer service and overall business intelligence.

What is claimed is:

1. PRIME will revolutionize the business-customer service relationship.

2. t will capture the Customer Preferences, via internet system monitoring and by direct opt-in interaction with the customer, thereby creating a dynamic real time link between Customer and business.

3. Over time PRIME'S vast and inclusive ultra-secure database will enable a business to accurately predict a customer's key needs via a precision demographic model.

4. This enables a business to extrapolate their customer's requirements in advance and to develop an accurate prediction and delivery methodology for products and services.

5. PRIME is ideally suited to businesses that are highly customer service oriented i.e.; hospitality, health care, financial, insurance, government, etc.

6. The PRIME environment is readily adaptable to any business that wants to excel in the level of customer service and surpass all competition.

7. By vastly improving elite levels of customer service at minimal expense, businesses will be able to grow and improve their bottom line.

8. PRIME has other utilities which enable precision delivery of goods and services in a time sensitive, coordinated and inventory rich environment.

9. PRIME requires minimal human resources to operate, its utilities are self monitoring, self analyzing, self adjusting, and self correcting and with the use of heuristic technology, self improving.
